(19) United States
(12) Patent Application Publication
(10) Pub. No.: US 2011/0228534 A1
(43) Pub. Date: Sep. 22, 2011

(54) HIGHLY-EFFICIENT AND HIGH-POWER LED LIGHT SOURCE, AN LED LAMP WHICH USES THE LIGHT SOURCE AND THE APPLICATION OF THE LAMP

(75) Inventors: Wenhu Zhang, Shanghai (CN); Qiuhua Zheng, Shanghai (CN)

(73) Assignee: Shanghai Cata Signal Co., Ltd., Shanghai (CN)

(21) Appl. No.: 13/129,877

(22) PCT Filed: Dec. 21, 2009
(86) PCT No.: PCT/CN2009/001520

§ 371 Date: May 18, 2011

(30) Foreign Application Priority Data
Jan. 22, 2009 (CN) 200920067294.4

(51) Int. Cl. F21V 5/04; H01K 1/30; F21V 29/00

(52) U.S. Cl. 362/240; 313/111; 362/294

(57) ABSTRACT

The present invention relates to a highly-efficient and high-power LED light source and LED lamp which uses the light source and the application of the lamp, particularly relates to a high-power LED light source and to a high-power LED lamp which uses such light source, and also to the application of such lamp. A highly-efficient and high-power LED light source comprising an LED, a condenser which condenses the light of the LED, wherein the said condenser is a concave mirror, and wherein the emitting part of the said LED is located at the focus of the concave mirror; and a converging lens which is located in front of the said LED, wherein the focus of the said converging lens is located at the emitting part of the said LED. The present invention solved the problem of low luminous efficiency of existing high-power LED light sources, and the problem of inadequate fullness and softness of the light emitted by existing high-power LED light sources.

### BACKGROUND

1. Field of the Invention

The present invention relates to a LED lamp, and more particularly, to a high-power LED light source. It also relates to a high-power LED lamp which uses such light source, and the application of such lamp.

2. Related Art

Currently, people all over the world are seeking for solution of the conflict between economic development and energy shortage. As the light-emitting diode (LED) technology develops, its cost drops rapidly. As a result, the LED technology has been used more and more widely in fields of automobile lighting, traffic signal devices, and illumination. The development and application of LED lamps will inevitably bring a broad market prospect and new opportunities of economic development for the entire energy-efficient lighting and green lighting industry, while the high-power LED is an inevitable choice for lighting appliances.

In recent years, the optical model of the single Total Internal Reflected (TIR) resin converging lens 1, equipped with the corresponding high-power LED has been used in most designs and applications of such high-power LED lamps at home and abroad so as to collect optical energy and collimate light rays (see FIG. 1). TIR resin converging lens 1 consists mostly of one piece of substantial transparent resin and it is required that the entire piece of resin be highly glabrous on the surface with highly uniform internal density and high transmittance. Therefore, the production process of TIR resin converging lens 1 is complicated, and the cost is higher. Furthermore, the single TIR resin converging lens 1 can only be used to make LED light source products with small light spots, not large-scale surface light source LED lamps, and its application and lighting effect are thus limited.

In addition to the above problems, there are still other disadvantages: the luminous efficiency of lamps using this optical model is generally low, and there are bright spots on the emitting surface because of regional light concentration. A number of bright spots appear when LEDs are arranged sparsely, causing a negative effect on the overall fullness and softness of the light emitted by high-power LED lamps.

### SUMMARY OF THE INVENTION

The first technical problem to be solved by the present invention is to provide a high-power LED light source with a front converging lens to improve the luminous efficiency of the existing high-power LED light source, and to enhance the fullness and softness of the light.

The second technical problem to be solved by the present invention is to provide a lamp which uses the said LED light source.

The third technical problem to be solved by the present invention is to provide applications of the said lamp.

As the first aspect of the present invention, a high-power LED light source comprises an LED, and a condenser which concentrates the light emitted by the LED, wherein the said condenser is a concave mirror/lens, and the emitting part of the said LED is located at the focus of the said concave mirror; and a converging lens which is located in front of the said LED, wherein the focus of the said converging lens is at the emitting part of the said LED, or in the vicinity of the emitting part of the said LED according to the requirement of the optical design to meet the functional demands of different lamps. The location of the emitting part of the said LED at the focus of the said concave mirror facilitates the emitting of highly-efficient and collimated light beams and the formation of a surface light source.

The said converging lens is a lens with a condensing function, e.g. a convex lens, and the preferred embodiment is a Fresnel lens which fully concentrates the light scattered outside the condensing wrap angle in front of the concave mirror to maximize the overall condensing efficiency of the LED light source.

As the second aspect of the present invention, a lamp comprises a casing, wherein a certain number of closely-spaced high-power LED light sources are located in the said casing with each high-power LED light source comprising an LED and a condenser which concentrates the light emitted by the LED, and wherein the said condenser is a concave mirror and the emitting part of the said LED is located at the focus of the said concave mirror; a converging lens located in front of the said LED, wherein the focus of the said converging lens is located at the emitting part of the said LED or in the vicinity of the emitting part of the said LED according to the final optical design to meet the functional demands of different lamps. The location of the emitting part of the said LED at the focus of the said concave mirror facilitates the emitting of highly-efficient and collimated light beams and such closely spaced high-power LED light sources can produce suitable high-density collimated light beams, forming a surface light source thus facilitating the light distribution design of the lamp.

The said converging lens may be a lens with condensing function, such as a convex lens. The preferred embodiment of the converging lens is a Fresnel lens.

In the lamp of the present invention, the concave mirror and the converging lens of each high-power LED light source concentrate the light emitted by the LED in the same direction, i.e. the emitted light beams have the same emitting direction. The adoption of multiple LEDs can effectively improve the intensity of the light and adoption of the above-mentioned technical scheme can effectively improve the directivity of the light.

In the lamp of the present invention, the concave mirrors of each high-power LED light source are placed closely on the same plane and the light beams emitted by each LED are therefore arranged tightly, making the light emitted by the lamp full, well-distributed and without scattered glaring bright spots as a whole.

In the lamp of the present invention, the said high-power LED light sources can be arranged in either a honeycombed shape or a rectangular array.

In the lamp of the present invention, the concave mirrors of each high-power LED light source are interconnected.

The converging lens of each high-power LED light source can be located at a proper position in relation to the LED light source individually or located at a proper position in relation to the LED light sources as one integrated piece.

The lamp of the present invention also comprises a printed wiring board, where the LEDs of the high-power LED light source are set. A metal-based heat sink cooling plate is set on the said printed wiring board.

In the lamp of the present invention, the LED of the high-power LED light source can be a monochromatic single-chip high-power LED or a monochromatic multi-chip high-power LED, or a multi-chip color-changeable high-power LED.

In the lamp of the present invention, a transparent cover or a diffusing lens which can diffuse and distribute the light is set in front of the converging lenses of the said high-power LED light sources. The surface of the said diffusing lens is densely covered with diffusing particles. The said diffusing particles are lenses with light-diffusing function. The light beams emitted by each LED are diffused by the diffusing lens to a certain angle so as to meet the requirements of different functions of the lamps. When used together with an atomized soft-light lens or a soft-light lens added with light diffusing agent, the lamp can emit light which is even softer and fuller as a whole.

When a convex lens is adopted as the converging lens of the present invention, the manufacture of the convex lens is easy because optical parameters of the convex lens are easy to control, and costs of the mould are low. In addition, the convex lens is easy to clean for the smooth surface.

When a Fresnel lens is adopted as the converging lens of the present invention, the costs as well as the overall weight of the product can be reduced since less material is used.

A rear cover is set behind the said casing for eliminating the heat from the LED, and the said metal-based heat sink is compressed tightly to the said rear cover.

The third aspect of the present invention relates to the application, wherein the lighting appliance can be used for indoor lighting, automobile lighting, road lighting or advertising lighting or as searchlight.

Based on the above-mentioned design, the present invention is particularly suitable for high-power LED lamps where the power of a single LED is more than 0.5 W.

The original high-power LED lamp only adopts TIR lens as the condenser, especially the single Total Internal Reflection (TIR) resin converging lens. The TIR resin converging lens consists mostly of one piece of substantial transparent resin and the entire piece of resin must be highly polished on the surface with highly uniform internal density and high transmittance. Therefore, the production process of such TIR resin converging lens is complicated and the cost is high. Furthermore, the single TIR resin converging lens can only be used to fabricate a small-scale light source product, not a large-caliber LED light source product. Within a certain range of power, the number of LEDs is limited. As a result, light beams emitted by such light sources are relatively narrow. Therefore, the light emitted by the lamps with such light sources will have a large number of apparent bright spots when LEDs are sparsely spaced. Such tiny bright spots pose a negative effect on the overall fullness and softness of the light emitted by the high-power LED lamps, and thus affect the lighting effect and limit its application scope.

In the above-mentioned technical scheme of the present invention, a concave mirror and a converging lens are adopted instead of the original TIR lens, bringing the following technical effects:

Firstly, the production processes of the concave mirror and the converging lens are well developed. The concave mirror is a common condenser used for car lighting, flashlight, etc. Its cost is low, and the concave mirror with large caliber can easily be produced. The convex lens or the Fresnel lens which is used as the converging lens is also characterized by its low cost, and the large convex lens or the Fresnel lens with large area is also easily produced. By adopting the concave mirror with large caliber and the convex lens or the Fresnel lens with large area, the cross-sectional area of the light beams will increase significantly, and thus, when LEDs are sparsely spaced, there will not be many bright spots, making the light emitted from the high-power LED lamps fuller and softer, the overall lighting effect better and the application scope wider.

Other devices, apparatus, systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWING FIGURES

The invention may be better understood by referring to the following figures. The components in the figures are not necessarily to scale, emphasis instead being placed upon illustrating the principles of the invention. In the figures, like reference numerals designate corresponding parts throughout the different views.

FIG. 1 is a structure drawing of a prior art high-power LED lamp.

FIG. 2 is a cross-sectional view of a lamp and its high-power LED light source of the present invention.

FIG. 3 is a front view of a lamp and its high-power LED light source of the present invention.

FIG. 4 is a structural drawing of the first embodiment of application of the present invention.

FIG. 5 is a structural drawing of the second embodiment of application of the present invention.

FIG. 6 is a structural drawing of the third embodiment of application of the present invention.

### DETAILED DESCRIPTION OF THE PREFERRED EMBODIMENTS

In order to make the technical means, characteristics, purpose, and effect of the present invention easy to understand, a further description of the present invention is given as below with reference to the corresponding drawings.

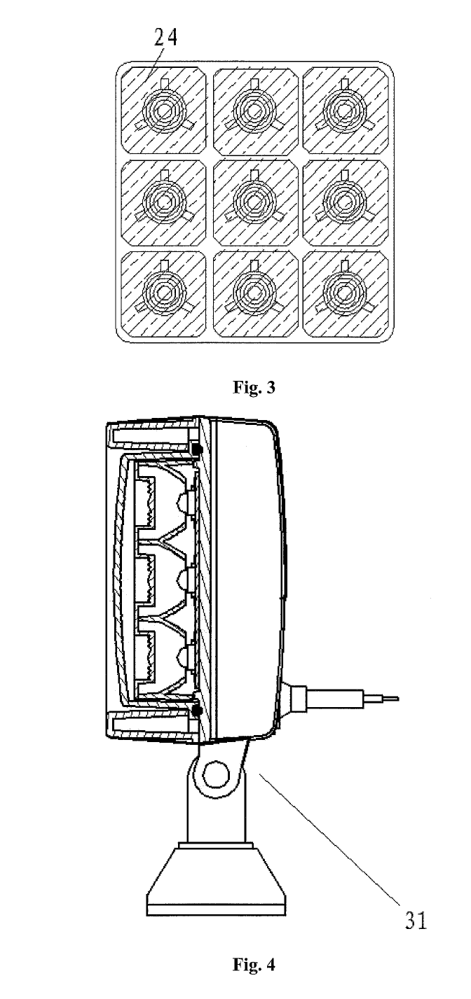

Referring to FIGS. 2 and 3, the lamp comprises a casing 2, wherein several high-power LED light sources are closely spaced inside the casing 2. These high-power LED light sources can be arranged either in a honeycombed shape or in a rectangular array (as shown in FIG. 2).

Each high-power LED light source comprises LED 21, and a concave mirror 22 which condenses the light is placed on top of the LED 21. The emitting part of the LED 21 is located at the focus of the concave mirror 22. The converging lens 23 is set in front of the LED 21, and the focus of the converging lens 23 is located at the emitting part of the LED 21. This design facilitates the emitting of collimated light beams and is suitable for occasions where collimated light beams are needed. The converging lens 23 can be either a convex lens or a Fresnel lens.

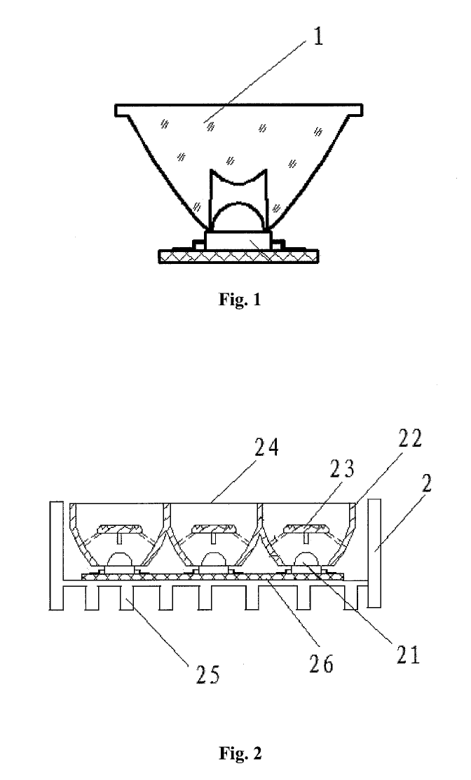

Referring to FIG. 1, most prior art high-power LED lamps only use a TIR lens as a condenser, especially single Total Internal Reflection (TIR) resin converging lens 1. The TIR resin converging lens 1 consists mostly of one piece of substantial transparent resin. It is required that the entire piece of resin shall be highly polished on the surface, with highly uniform internal density and high transmittance. Thus the production process of the TIR resin converging lens 1 is complicated, and the cost is high. Furthermore, such TIR resin converging lens 1 can only be used for fabricating small-scale light source products. It cannot be used for producing LED light source products with large caliber. Therefore, it can only emit narrow concentrated light beams. Within a certain range of power, the number of LEDs used is limited. When LEDs are arranged sparsely to keep the necessary shape and dimension of the lamp, the light emitted by the lamp will have a large number of apparent bright spots. Such tiny bright spots will cause a negative effect on the general fullness and softness of the light emitted by the high-power LED lamp, and limit the application range and affect the lighting effect.

Referring to FIG. 2, in the above-mentioned technical scheme of the present invention, a concave mirror 22 and a converging lens 23 are adopted instead of the original TIR resin converging lens 1, bringing the following technical effects:

Firstly, the production processes of concave mirror 22 and converging lens 23 are well developed. A concave mirror is a common condenser used for car lighting, flashlight, etc. Its cost is low, and the concave mirror 22 with large caliber can be easily produced. A convex lens or a Fresnel lens which is used as the converging lens 23 is also characterized by its low cost, and the convex lens or the Fresnel lens with large area can be easily produced. By adopting the concave mirror 22 with large caliber and the convex lens or Fresnel lens with large area, the cross-sectional area of light beams can be increased significantly, and thus, when LEDs are sparsely spaced, there will not be many bright spots, making the light emitted from the high-power LED lamps fuller and softer, the overall lighting effect better and the application scope wider.

When a convex lens is adopted as the converging lens 23 of the present invention, the convex lens will be easy to produce because the optical parameters of the convex lens are easy to control and the cost of the mould is low. In addition, the convex lens is easy to clean for the smooth surface. When a Fresnel lens is adopted as the converging lens 23 of the present invention, the cost as well as the overall weight of the product can be reduced since less material is used.

In the lamp of the present invention, the concave mirror 22 and converging lens 23 of each high-power LED light source concentrate the light in the same direction, i.e. the emitted light beams have the same emitting direction. The adoption of multiple LEDs can effectively improve the intensity of the light while adopting the above-mentioned technical scheme can improve the directivity of the light significantly.

The concave mirrors 22 of each high-power LED light source are placed closely on the same plane and the light beams emitted by each LED are therefore arranged tightly, making the light emitted by the lamp, as a whole, full and soft. The converging lens 23 of each high-power LED light source can also be integrated into one piece to facilitate installation of the lens.

These LEDs 21 of each high-power LED light source are set on a printed wiring board 26, and a metal-based heat sink is set on the printed wiring board 26. A heat cooling rear cover 25 used for cooling LED 21 is set behind the casing 2, and the metal-based heat sink is compressed tightly to the heating cooling rear cover 25 to dispel or eliminate the heat from of LED 21.

The LED of the high-power LED light source can be a monochromatic single-chip high-power LED or a multi-chip high-power LED or a multi-chip color-changeable high-power LED.

Referring to FIGS. 2 and 3, the diffusing lens 24 which can diffuse the light is set in front of the converging lens 22 of the high-power LED light sources. The surface of the diffusing lens 24 is densely covered with diffusing grain or particles. The diffusing particles or grains are convex lenses. The collimated light beams emitted by each LED are diffused directionally by the diffusing lens 24 to a certain degree to meet the light distribution demand of different functions of lamps. When used together with an atomized soft-light lens or a soft-light lens added with diffusion agent, the lamp can emit light which is even softer and fuller, as a whole.

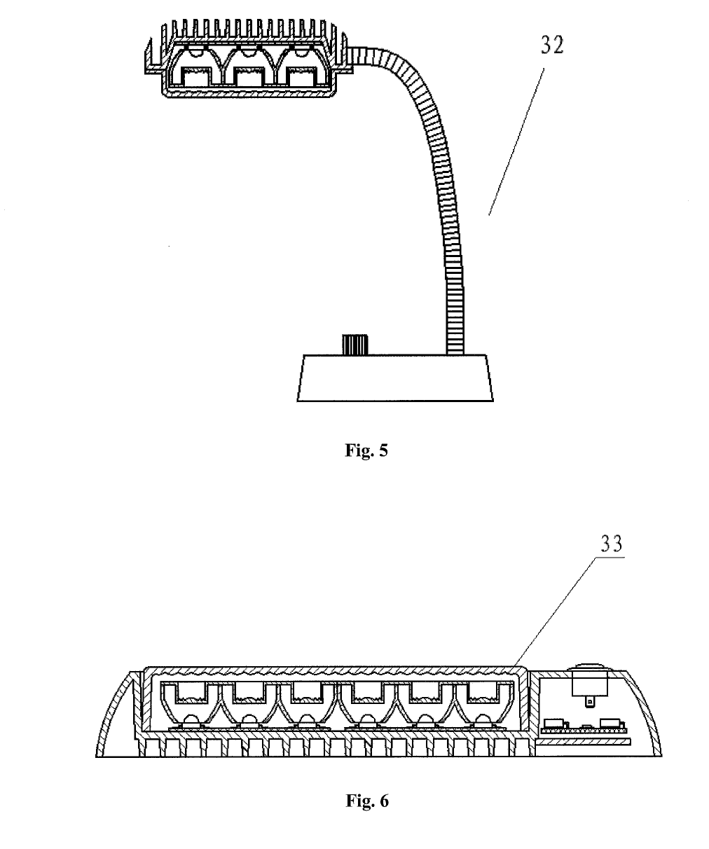

The lamp can be used as work light such as the work light 31 shown in FIG. 4, or, the lamp can be used for automobile lighting such as the automobile interior lamp 32 shown in FIG. 5. Or the lamp can be used for indoor lighting such as the desk lamp shown in FIG. 6. The lamps of the present invention can be used for fabrication of flashlights.

It is believed that the fundamental principle, key features and the advantages of the present invention are understood from the foregoing description. The technical personnel of the industry should understand that the present invention is not limited to the above embodiments. The embodiments and specifications hereinbefore described only explain the principle of the present invention, and it is apparent that various changes and improvements may be made thereto without departing from the spirit and scope of the invention. Such changes and improvements fall into the scope of the present invention which claims protection. The scope of protection claimed by the present invention is defined by the attached claims and their equivalents.

The foregoing description of implementations has been presented for purposes of illustration and description. It is not exhaustive and does not limit the claimed inventions to the precise form disclosed. Modifications and variations are possible in light of the above description or may be acquired from practicing the invention. The claims and their equivalents define the scope of the invention.

1. A high-power LED light source comprising: an LED, a condenser to concentrate the light emitted by the LED, wherein the said condenser is a concave mirror, and the emitting part of the said LED is located at the focus of the said concave mirror; and a converging lens located in front of the said LED, wherein the focus of the said converging lens is at the emitting part of the said LED.

2. The high-power LED light source as claimed in claim 1, wherein either the focus of the said concave mirror or the focus of the said converging lens can be located in the vicinity of the emitting part of the LED if needed.

3. The high-power LED light source as claimed in claim 1, wherein the said converging lens is a Fresnel lens or other convex lens that has a light condensing function.

4. A lamp comprising: a casing, a plurality of closely spaced high-power LED light sources in the casing, and wherein each high-power LED light source comprises an LED and a condenser which concentrates the light emitted by the LED, wherein the said condenser is a concave mirror, and wherein the emitting part of the said LED is located at the focus of the said concave mirror; and also comprising a converging lens located in front of the said LED, wherein the focus of the said converging lens is located at or proximate to the emitting part of the said LED.

5. The lamp as claimed in claim 4, wherein the said converging lens is a Fresnel lens or other convex lens which has a condensing function.

6. The lamp as claimed in claim 4, wherein the said concave minor and the said converging lens of each high-power LED light source concentrate the light in the same direction, i.e. the emitted light beams have the same emitting direction.

7. The lamp as claimed in claim 4, wherein the concave mirrors of each high-power LED light source are placed closely on the same plane.

8. The lamp as claimed in claim 4, wherein the said high-power LED light sources are arranged in a honeycombed shape.

9. The lamp as claimed in claim 4, wherein the said high-power LED light sources are arranged in a rectangular array.

10. The lamp as claimed in claim 4, wherein the converging lens of each high-power LED light source can be set in a proper position in relation to the LED light source either separately or as one integrated piece.

11. The lamp as claimed in claim 7, wherein the concave mirrors of each high-power LED light source are interconnected.

12. The lamp as claimed in claim 4, wherein the lamp also comprises a printed wiring board, wherein the LEDs of each high-power LED light source are set on the said printed wiring board.

13. The lamp as claimed in claim 12, wherein a metal-based heat sink is set on the said printed wiring board.

14. The lamp as claimed in claim 13, wherein, a heat cooling rear cover is set behind the said casing for cooling the said LED, and the said metal-based heat sink is compressed tightly to the said heat cooling rear cover.

15. The lamp as claimed in claim 4, wherein the LED of the said high-power LED light source is a monochromatic single-chip high-power LED.

16. The lamp as claimed in claim 4, wherein the LED of the said high-power LED light source is a monochromatic multi-chip high-power LED.

17. The lamp as claimed in claim 4, wherein the LED of the said high-power LED light source is a multichip color-changeable high-power LED.

18. The lamp as claimed in claim 4, wherein a transparent cover is set in front of the converging lenses of the high-power LED light sources.

19. The lamp as claimed in claim 4, wherein a diffusing lens which diffuses the light is set in front of the converging lens of the high-power LED light sources.

20. The lamp as claimed in claim 19, wherein the surface of the said diffusing lens is densely covered with diffusing grains or pits.

21. The lamp as claimed in claim 20, wherein the said diffusing grains are convex lenses with a light-diffusing effect.

22. The lamp as claimed in claim 20, wherein the said diffusing pits are concave lenses with a light-diffusing effect.

23. The lamp as claimed in claim 19, wherein the said diffusing lens includes an atomized soft-light lens or a soft-light lens added with light diffusing agent.

24. A lamp as claimed in claim 4, wherein the lamp is used in a work light.

25. A lamp as claimed in claim 4, wherein the lamp is used in an indoor light.

26. A lamp as claimed in claim 4, wherein the lamp is used in a car light.

27. A lamp as claimed in claim 4, wherein the lamp is used in a road light.

28. A lamp as claimed in claim 4, wherein the lamp is used in an advertising light.

29. A lamp as claimed in claim 4, wherein the lamp is used in an engineering light.

30. A lamp as claimed in claim 4, wherein the lamp is used in the fabrication of a flashlight.

31. A lamp comprising:
a casing;
a high-power LED light source disposed in the casing;
wherein the high-power LED light source includes an LED and a condenser, which condenser includes a concave mirror such that a light emitting part of said LED coincides with the focus of said concave mirror;
a converging lens located in front of said LED and said casing, wherein the focus of said converging lens coincides with said light emitting part of the said LED;
a metal-based heat sink disposed behind said high-power LED light source; and
a heat dissipating rear cover to said casing, wherein said rear cover engages said heat sink.
